(19) United States
(12) Patent Application Publication
(10) Pub. No.: US 2009/0248908 A1
(43) Pub. Date: Oct. 1, 2009

(54) APPARATUS FOR INPUTTING CHARACTERS AND METHOD FOR SUPPORTING KEYBOARD FUNCTIONS

(75) Inventor: Jaewoo Ahn, Seongnam-si (KR)

Correspondence Address: CANTOR COLBURN, LLP, 20 Church Street, 22nd Floor, Hartford, CT, 06103, US

(73) Assignee: MOBIENCE, INC., Seongnam-si (KR)

(21) Appl. No.: 12/296,044

(22) PCT Filed: Apr. 6, 2007
(86) PCT No.: PCT/KR2007/001699

§ 371 Date: Oct. 3, 2008

(30) Foreign Application Priority Data
Apr. 6, 2006 (KR) 10-2006-0031527
May 22, 2006 (KR) 10-2006-0045901
Jun. 14, 2006 (KR) 10-2006-0053280
Dec. 27, 2006 (KR) 10-2006-0135001

(51) Int. Cl. G06F 3/00; G06F 13/12

(52) U.S. Cl. 710/14; 710/65

(57) ABSTRACT

Disclosed is a method and apparatus for inputting characters as many as possible with a limited number of keys.

### TECHNICAL FIELD

The present invention relates to a method and apparatus for inputting characters as many as possible with a limited number of keys.

### BACKGROUND ART

Advanced semiconductor technologies have resulted in more compact and high-performing portable terminals, such as mobile phones and personal digital assistants (PDAs). However, their input means are an obstacle to the compact portable terminals which require input keys as many as computer keyboards.

### DISCLOSURE OF INVENTION

### Technical Problem

In order to avoid the obstacle, the conventional portable terminals have a computer keyboard which is reduced in size as much as possible. However, there is a limit in reducing the size of the keyboard.

### Technical Solution

The present invention provides a method and apparatus for inputting with a limited number of keys all characters provided on a computer keyboard.

Additional features of the invention will be set forth in the description which follows, and in part will be apparent from the description, or may be learned by practice of the invention.

### ADVANTAGEOUS EFFECTS

According to the present invention, it is possible to input characters of a computer keyboard using a typical portable terminal having a limited number of keys. In addition, it is possible to provide keys which are assigned applications or user-defined functions.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a keyboard character input apparatus according to an exemplary embodiment of the invention.

FIG. 2 illustrates a keyboard character input apparatus according to an exemplary embodiment of the invention.

FIG. 3 is a flow chart of a method for inputting a keyboard character according to another exemplary embodiment of the invention.

FIG. 4 illustrates a key selection unit with an array of 6 rows and 3 columns according to an exemplary embodiment of the invention.

FIGS. 5 to 8 illustrate character mode changes in a text mode.

FIG. 9 illustrates symbol keys assigned in a text mode.

FIG. 10 illustrates keys assigned when a text mode is changed to a keyboard mode.

FIG. 11 illustrates a keyboard related to FIG. 10.

FIG. 12 illustrates assigned function keys of a keyboard.

FIG. 13 illustrates a keyboard related to FIG. 12.

FIG. 14 illustrates assigned movement keys of a keyboard.

FIG. 15 illustrates a keyboard related to FIG. 14.

FIGS. 16 to 21 illustrate assignment of character keys of a keyboard.

FIGS. 22 to 27 illustrate assignment of numeral, symbol, and remainder keys of a keyboard.

FIGS. 28 to 30 illustrate keyboards related to FIGS. 22 to 24, respectively.

FIG. 31 illustrates assigned system keys.

FIG. 32 illustrates assigned audio-related keys.

FIG. 33 illustrates assigned screen-related keys.

FIG. 34 illustrates assigned network-related keys.

FIG. 35 illustrates assigned power-related keys.

FIG. 36 illustrates assigned user-defined application keys.

FIG. 37 illustrates assigned user-defined keys.

FIG. 38 illustrates a key selection unit according to another exemplary embodiment of the invention.

### BEST MODE FOR CARRYING OUT THE INVENTION

The present invention discloses an apparatus for inputting characters provided on a computer keyboard, including: a key selection unit having a limited number of keys; and a key processing unit which assigns characters to at least some of the limited number of keys in a text mode and outputs a character of a selected key, and which assigns keys of the computer keyboard to at least some of the limited number of keys in a keyboard mode and processes a key selected by the key selection unit.

The key processing unit may reassign other keys of the computer keyboard to at least some of the limited number of keys when the key selected by the key selection unit is input in the keyboard mode.

The present invention also discloses a method for inputting characters provided on a computer keyboard, including: assigning characters to at least some of a limited number of keys of a key selection unit in a text mode, and outputting a character of a selected key; and assigning keys of the computer keyboard to at least some of the limited number of keys in a keyboard mode, and processing a selected key.

The step of assigning keys of the computer keyboard may include reassigning other keys of the computer keyboard to at least some of the limited number of keys when a key selected by the key selection unit is input in the keyboard mode.

It is to be understood that both the foregoing general description and the following detailed description are exemplary and explanatory and are intended to provide further explanation of the invention as claimed.

### Mode for the Invention

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

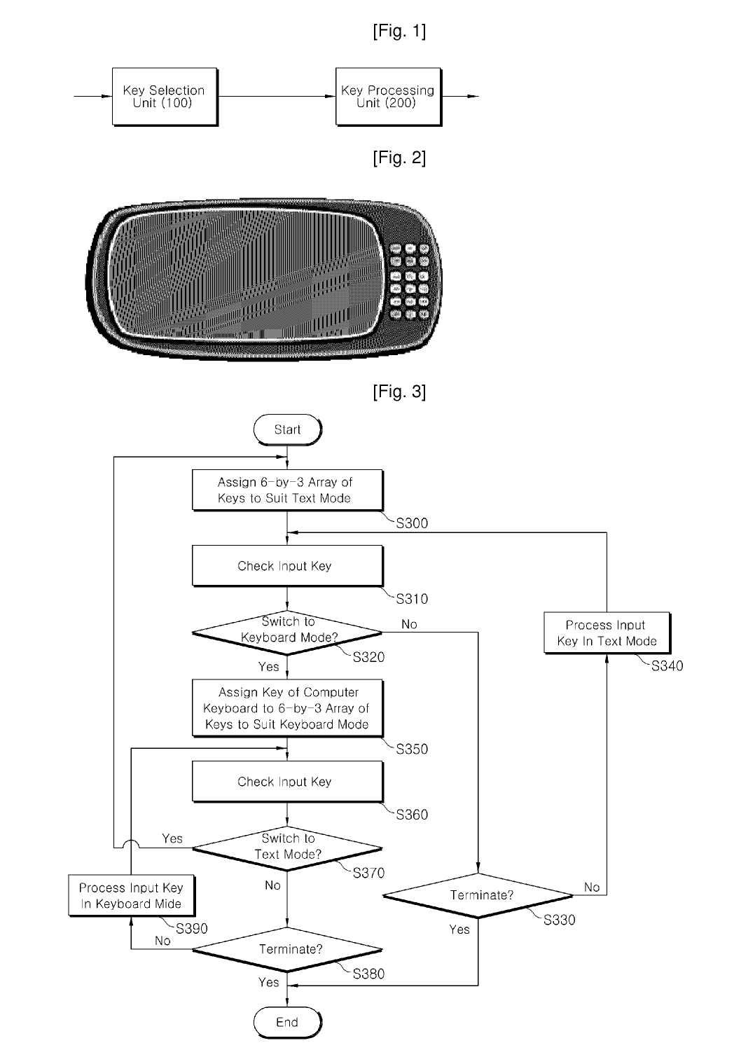

FIG. 1 is a block diagram of a keyboard character input apparatus according to an exemplary embodiment of the invention.

The keyboard character input apparatus includes a key selection unit 100 and a key processing unit 200. The key selection unit 100 consists of a limited number of keys. The key selection unit 100 preferably has an array of 6 rows and 3 columns, which consists of 36 keys. The key selection unit 100 is displayed on a display and allows a user to select the keys.

FIG. 2 illustrates a keyboard character input apparatus according to an exemplary embodiment of the invention.

The keyboard character input apparatus has a physical key input unit. Although not shown in FIG. 2, the key selection unit 100 having an array of 6 rows and 3 columns is displayed on its display. The key input unit also has an array of 6 rows and 3 columns. The user selects keys on the key selection unit 100 through the key input unit.

In addition to the key input unit, the key selection unit 100 is displayed on the display since the key selection unit 100 has keys which may be differently defined if necessary.

Even though the keyboard character input apparatus has no key input unit, the user can select the keys on the key selection unit 100. For example, a touch-screen, a remote control, a mouse or a joystick may be used to select the keys.

The key processing unit 200 analyzes keys selected through the key selection unit 100 and performs corresponding processes. For example, the key processing unit 200 displays on the display a character corresponding to a key selected in a text mode, or displays on the display an Explorer corresponding to a key selected in a keyboard mode. The key processing unit 200 may define the selected key differently.

FIG. 3 is a flow chart of a method for inputting a keyboard character according to another exemplary embodiment of the invention.

In a text mode, the key processing unit 200 assigns characters to at least some of keys of, for example, 6 rows and 3 columns (hereinafter referred to as 6-by-3) of the key selection unit 100 according to the text mode (step S300). In the text mode, English alphabets may initially be assigned. The key processing unit 200 checks a key selected by the key selection unit 100 (step S310). When the key indicates switching to a keyboard mode (step S320), the key processing unit 200 assigns keys of a computer keyboard to at least some of 6-by-3 keys according to the keyboard mode (step S350). When the selected key indicates a termination key, the process is terminated (step S330). When the selected key indicates an execution key in the text mode, for example, outputting a character or changing a character mode is preformed (step S340).

After the step S350, the key processing unit 200 checks a key selected by the key selection unit 100 (step S360). When the key indicates switching to the text mode (step S370), the process returns to the step S300. When the key indicates a termination key, the process is terminated (step S380). When the selected key indicates an execution key in the keyboard mode, for example, executing an instruction or changing key-assignment is preformed (step S390). For example, when a function key is input, the key processing unit 200 executes the function key.

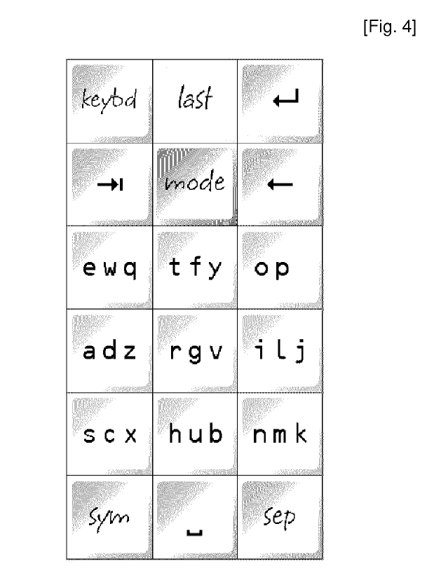

FIG. 4 illustrates a key selection unit with 6-by-3 keys.

FIG. 4 shows a 6-by-3 key array in a text mode in which English alphabets are initially assigned to at least some of the keys. The text mode allows a user to input characters which a typical mobile terminal has.

For example, 3-by-3 English alphabets are provided as shown in FIG. 4. While the English alphabets may be assigned otherwise, the English alphabets are preferably assigned as shown in FIG. 4 so that the user can input characters conveniently and quickly.

The English alphabet array shown in FIG. 4 is set by considering the QWERTY array and the usage frequency of English alphabets. The QWERTYT array has a first group consisting of English alphabets inputted with a left hand, and a second group consisting of English alphabets inputted with a right hand.

That is, the first group consists of “q”, “w”, “e”, “r”, “t”, “a”, “s”, “d”, “f”, “g”, “z”, “x”, “c”, “v”, and “b” and the second group consists of “y”, “u”, “i”, “o”, “p”, “h”, “j”, “k”, “l”, “n”, and “m”. The first group is placed on the left or center of the 3-by-3 array, and the second group is placed on the right or center of the 3-by-3 array.

Furthermore, the English alphabets are divided into a first character set, a second character set, and a third character set according to the usage frequency, and a plurality of English alphabets assigned adjacent keys in the QWERTY array are assigned to the same key or adjacent keys.

For example, the first character set includes English alphabets consisting of “a”, “e”, “h”, “i”, “n”, “o”, “r”, “s”, and “t”, which have the highest usage frequency, the second character set includes English alphabets consisting of “c”, “d”, “f”, “g”, “l”, “m”, “p”, “u”, and “w” and the third character set includes English alphabets consisting of “b”, “j”, “k”, “q”, “v”, “x”, “y”, and “z”.

The respective character sets may have usage frequencies different from actual usage frequencies to make an array similar to the QWERTY array. For example, even though “y” has a usage frequency a little higher than “p”, “y” belongs to the third character set and “p” belongs to the second character set.

The above-mentioned character array and input method are described in Korean Laid-Open Patent Application No. 2004-82326, and a detailed description thereof will be omitted herein.

Among the keys shown in FIG. 4, the Enter key, Tab key, Backspace key, and Space key are well known and a detailed description thereof will be omitted herein. The Separator ([sep]) key is used when consecutively inputting characters assigned to the same key, so that a current input character can be distinguished from the next input character. The [sep] key is also well known and a detailed description thereof will be omitted herein.

The [last] key is used to repeatedly input the last character. For example, conventionally, the character “e” is consecutively input twice by pushing the [ewq] key once, and pushing the [ewq] key again after a predetermined time or pushing the [sep] key.

In order to avoid such inconvenience, the [last] key is used in the present embodiment of the invention. For example, when the [ewq] key is pushed once and then the [last] key is pushed, the character “e” is consecutively input twice. When the [ewq] key is pushed once and then the [last] key is pushed twice, the character “ew” is input. That is, when the [last] key is pushed, the last key is input again.

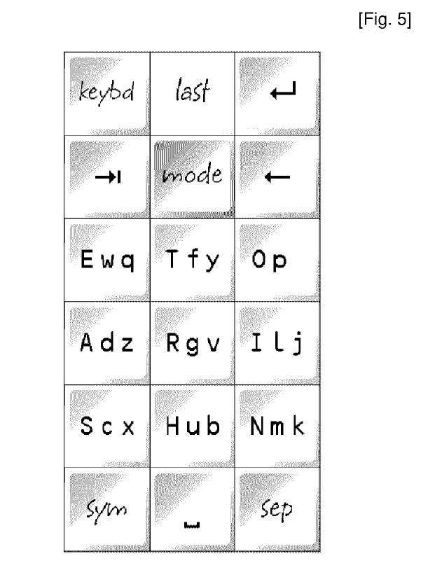

The [mode] key is used to change a character mode in the text mode. For example, when the [mode] key is input in a lowercase mode shown in FIG. 4, the key processing unit 200 changes a first character of each of the keys to an upper case as shown in FIG. 5. This is called a sentence mode in which the first character is input as an upper case and the rest are input as lower cases. The character mode is preferably changed to the lowercase mode after a first character is input as an upper case.

For example, when a sentence is initially input, the upper case “E”, “W” and “Q” are input when the [Ewq] key is pressed once, twice, and third times, respectively. Preferably, when a first upper case is input in a sentence mode, a changed alphabet may be automatically assigned. For example, when the [Ewq] key is consecutively pushed before a predetermined time elapses to input an upper case as a first character in a sentence mode, English alphabets are automatically changed and assigned in the order of [eWq], [ewQ] and [Ewq].

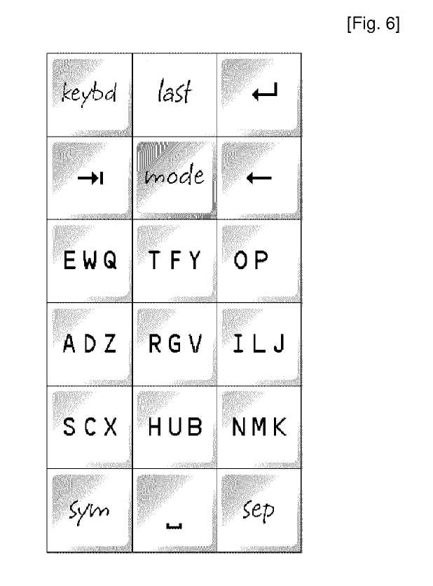

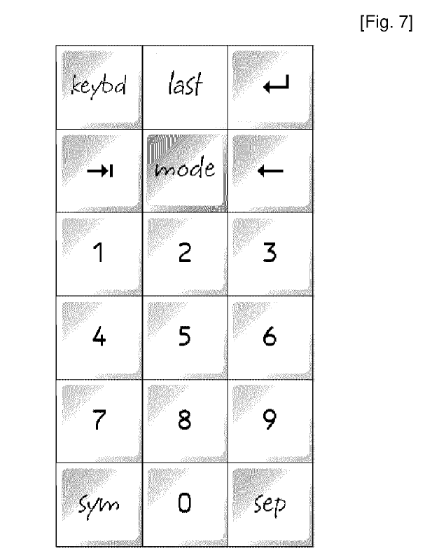

When the [mode] key is input in FIG. 5, the key processing unit 200 changes the character mode to an uppercase mode and assigns upper cases to the keys as shown in FIG. 6. When the [mode] key is input in FIG. 6, the key processing unit 200 changes the character mode to a numeral mode as shown in FIG. 7.

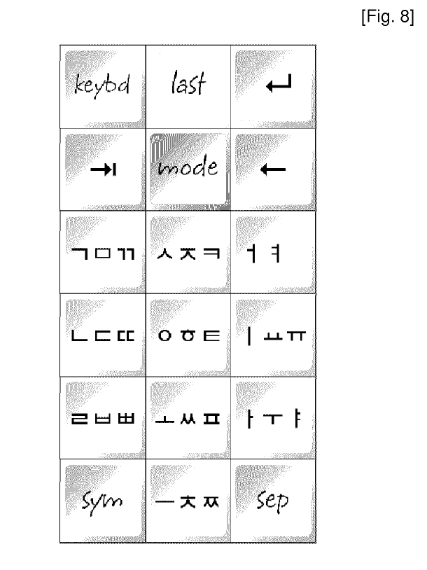

When the [mode] key is input in FIG. 7, the key processing unit 200 assigns an additional mode, such as Hanguel, the Korean alphabet, as shown in FIG. 8. When the [mode] key is input in FIG. 8, the key processing unit 200 changes back to the lowercase mode shown in FIG. 4.

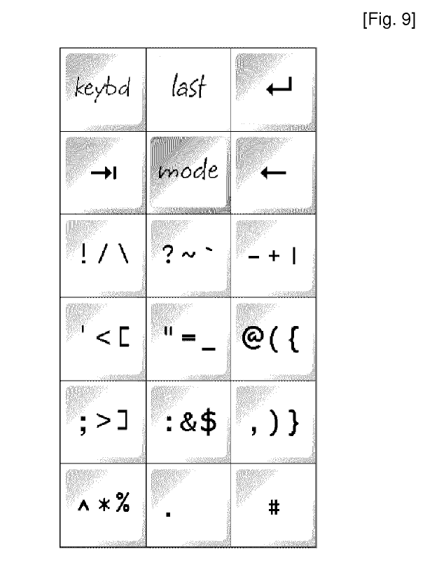

FIG. 9 illustrates a symbol key mode in the text mode.

When the [sym] key is input in FIGS. 4 to 8, the key processing unit 200 assigns, for example, symbols as shown in FIG. 9. That is, the [sym] key allows users to input symbols in any character mode in the text mode. For example, when a symbol is input in the symbol key mode shown in FIG. 9, the key processing unit 200 processes such that the symbol is output and then the mode is returned to the previous character mode.

The Hangeul keys shown in FIG. 8 are assigned considering the usage frequency, the relation with the continuous keyboard system etc. The symbol keys shown in FIG. 9 are preferably assigned considering similarity with numerals, usage frequency etc. The above-mentioned Hangeul array and symbol array shown in FIGS. 8 and 9 are described in the above-mentioned Korean Laid-Open Patent Application No. 2004-82326, and a detailed description thereof will be omitted herein.

A method for inputting keyboard characters will be described.

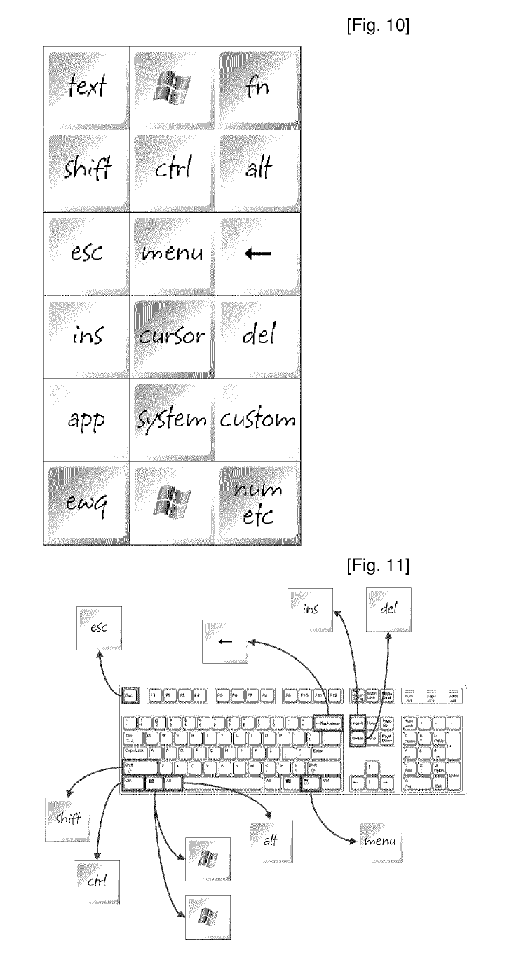

FIG. 10 illustrates keys assigned when a text mode is changed to a keyboard mode.

When the [keybd] key is input in the text mode shown in FIGS. 4 to 9, the key processing unit 200 changes the text mode to a keyboard mode and assigns keys of a computer keyboard to at least some of keys of the key selection unit 100. As shown in FIG. 10, the key selection unit 100 includes the Esc key, Ins key, Del key, Backspace key, Combination key etc. Examples of the Combination key include the Shift key, Ctrl key, Alt key, and Window key, which are used together with other keys and are toggled.

The key processing unit 200 processes the Esc key, Ins key, Del key, Backspace key, and Combination key in the same manner as the computer keyboard processes. The key processing unit 200 changes the color or shade of a character written on the combination key when the combination key is input, so that the toggling status can be identified.

FIG. 11 illustrates a computer keyboard related to FIG. 10.

The keys shown in FIG. 10 are ones which are marked with thick lines on the computer keyboard shown in FIG. 11.

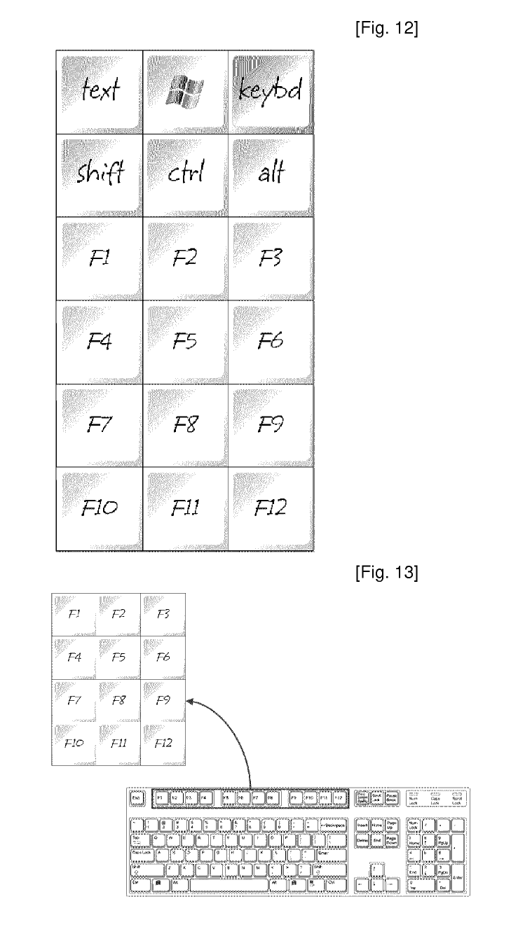

FIG. 12 illustrates assigned functions keys of the keyboard.

When the [fn] key is input in FIG. 10, the key processing unit 200 assigns F1 to F12 keys of the computer keyboard as shown in FIG. 12. The key processing unit 200 processes F1 to F12 keys which are input individually or in combination with the combination keys. For example, when F12 key is input on a MS-Word program, the key processing unit 200 loads a window named “Save as a different file name” like when F12 key is input on the computer keyboard.

FIG. 13 illustrates a computer keyboard related to FIG. 12.

The function keys shown in FIG. 12 are ones which are marked with thick lines on the computer keyboard shown in FIG. 13.

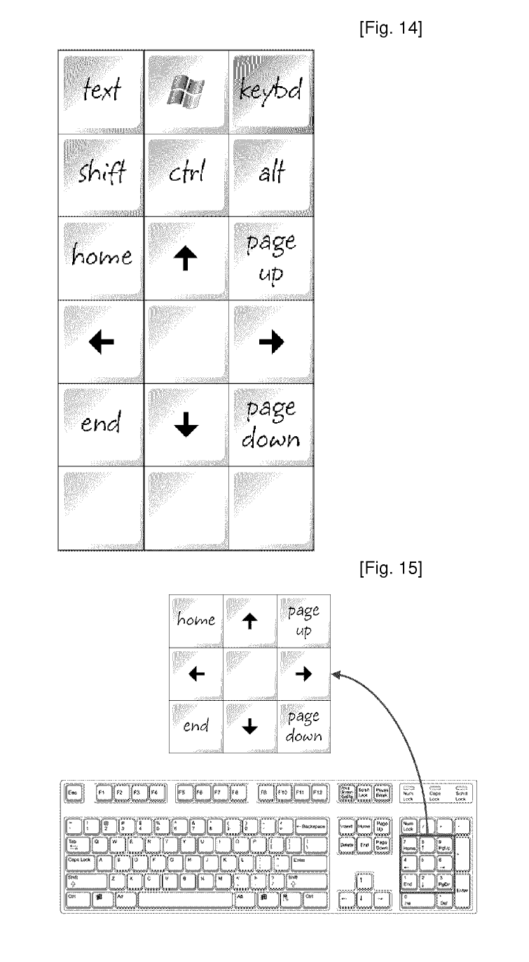

FIG. 14 illustrates assigned movement keys of the keyboard.

When the [cursor] key shown in FIG. 10 is input, the key processing unit 200 assigns cursor movement keys on the computer keyboard, such as “←” key, “→” key, “↑” key, “↓” key, Home key, End key, Page-up key, and Page-down key as shown in FIG. 14. The key processing unit 200 processes the input [cursor] key like when the movement keys are input on the keyboard.

FIG. 15 illustrates a computer keyboard related to FIG. 14.

The movement keys shown in FIG. 14 are ones which are marked with thick lines on the keyboard shown in FIG. 15.

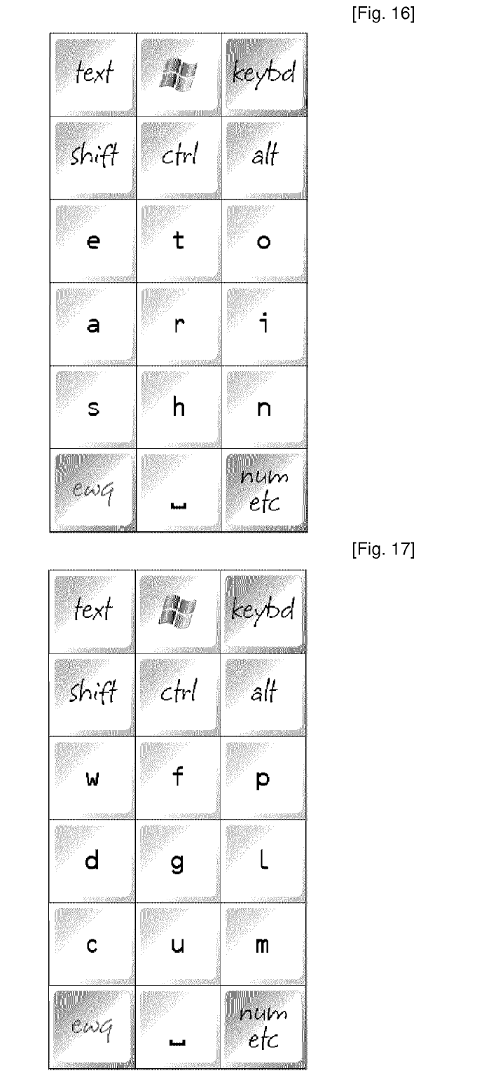

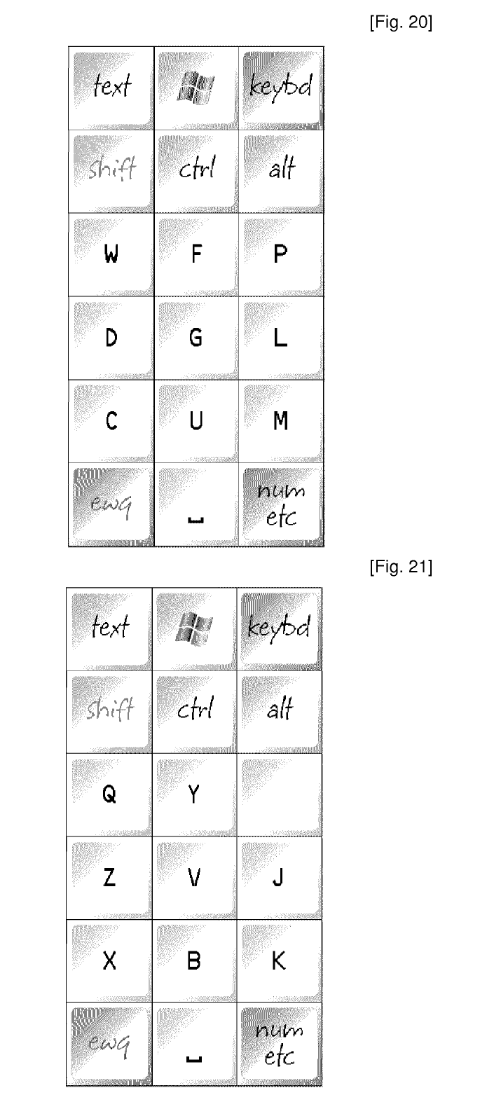

FIGS. 16 to 21 illustrate assignment of alphabet input keys of the keyboard.

When the [ewq] key shown in FIG. 10 is input, the key processing unit 200 assigns some of the English alphabets of the computer keyboard. Since the key selection unit 100 has a limited number of keys, 26 English alphabets cannot be assigned one-to-one to the keys. Therefore, some of the English alphabets are assigned one-to-one to the keys.

For example, when the [ewq] key shown in FIG. 10 is input, alphabets belonging to a first character set, a second character set, or a third character set are assigned one-to-one to the keys by the key processing unit 200. When the [ewq] key is input again, alphabets belonging to a character set other than the current character set are assigned one-to-one to the keys by the key processing unit 200.

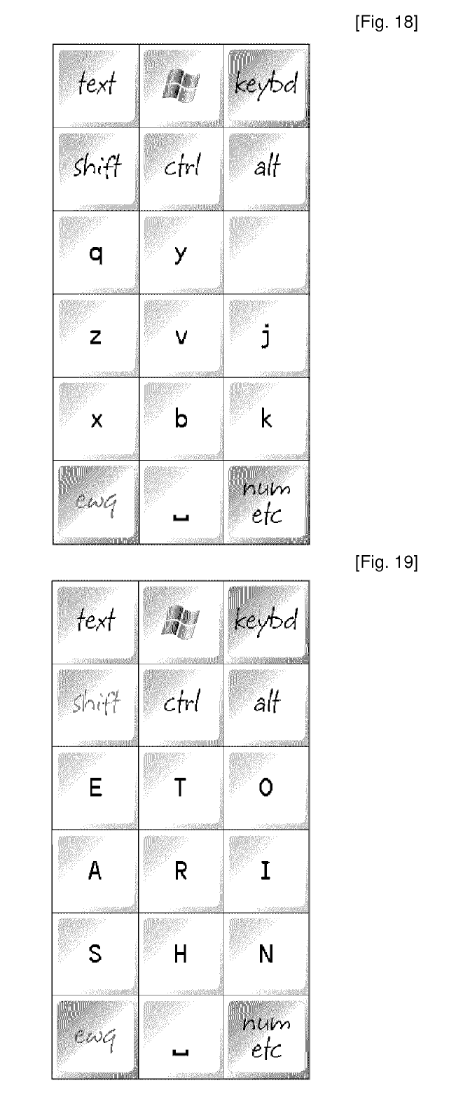

Preferably, whenever the [ewq] key is input, alphabets belonging to a first character set, a second character set, and a third character set are sequentially assigned one-to-one to the keys in this order by the key processing unit 200. That is, when the [ewq] key is first input, alphabets belonging to the first character set are assigned one-to-one to the keys by the key processing unit 200 as shown in FIG. 16. When the [ewq] key is input again in FIG. 16, alphabets belonging to the second character set are assigned one-to-one to the keys as shown in FIG. 17. In addition, when the [ewq] key is input again in FIG. 17, alphabets belonging to the third character set are assigned one-to-one to the keys as shown in FIG. 18.

The user can input lowercase alphabets through the key array of the key selection unit 100 shown in FIGS. 16 to 18, and the key processing unit 200 processes and displays the input alphabets on the display.

As described above, the first, second and third character sets are preferably divided based on the usage frequency of English alphabets. Therefore, the alphabets belonging to the first character set are “a”, “e”, “h”, “i”, “n”, “o”, “r”, “s”, and “t”, which have the highest usage frequency. The alphabets belonging to the second character set are “c”, “d”, “f”, “g”, “l”, “m”, “p”, “u”, and “w”. The alphabets belonging to the third character set are “b”, “j”, “k”, “q”, “v”, “x”, “y”, and “z”. They are preferably arranged in the alphabet array shown in FIG. 4.

When the [shift] key is input in FIGS. 16 to 18, the key processing unit 200 toggles the [shift] key and changes the lower case to the upper case as shown in FIGS. 19 to 21. This is similar to a case where the Shift key and an English alphabet key are pushed together on the keyboard, or where an English alphabet key is pushed with the CapsLock key turned on. That is, when an English alphabet key is pushed with the [shift] key activated, an upper case is displayed on the display.

Accordingly, the user can input uppercase alphabets on the key array of the key selection unit 100 shown in FIGS. 19 to 21, and the key processing unit 200 processes and displays the input alphabets on the display.

In addition to the [shift] key, the English alphabets can be input in combination with the other combination keys, such as [ctrl], [alt] and [windows] keys. For example, when the [windows] key is activated and the alphabet “e” is input, the key processing unit 200 loads the “Explorer window” like when the windows key and the alphabet “e” key are pushed on the computer keyboard.

For another example, when the [ewq] key shown in FIG. 10 is input, the key processing unit 200 assigns the English alphabet array shown in FIG. 4 so that one of the alphabets assigned to the keys can be input. For instance, when a computer is used with a mouse having three buttons, a first alphabet of each key is input by clicking the left of the mouse, a second alphabet is input by clicking the middle of the mouse, and a third by the right of the mouse.

More preferably, when the [ewq] key shown in FIG. 10 is input, the key processing unit 200 assigns alphabets to a 3-by-3 array of nine keys among the limited number of keys of the key selection unit 100. In this case, the alphabets on the computer keyboard are divided into a first group consisting of alphabets, which are input with a left hand, and a second group consisting of alphabets, which are input with a right hand. The alphabets belonging to the first group are arranged on the left or center columns of the 3-by-3 array, and the alphabets belonging to the second group are arranged on the right or center columns. The alphabets belonging to the first, second and third character sets, which are divided based on the usage frequency of the alphabets, are assigned one by one.

The array of alphabets thus arranged is the same as that of FIG. 4. This allows the characters to be efficiently input.

When the alphabets are assigned in the keyboard mode as shown in FIG. 4, lower cases or upper cases may be input as shown in FIG. 4 or 6 by toggling the [shift] key.

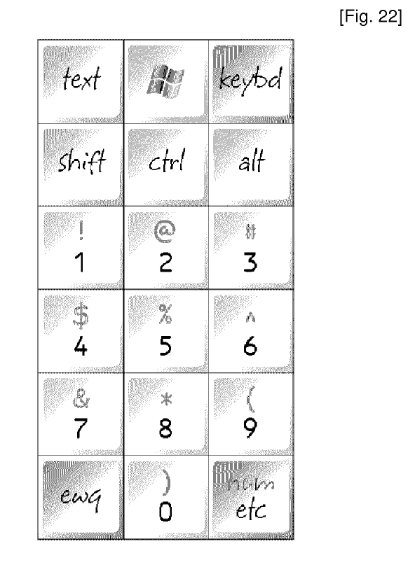

FIGS. 22 to 27 illustrate assignment of numeral, symbol and other keys of a keyboard.

When the numeral keys and the other keys, such as [num etc] key, shown in FIGS. 10, 12, 14, and 16 to 21 are input, the key processing unit 200 assigns keys having both numeral and symbol as shown in FIG. 22. The symbol can be input when the [shift] key is activated. Therefore, when the [shift] key is not activated, the numerals “0” to “9” are marked thickly as shown in FIG. 22 to indicate that the numerals can be input. When the [shift] key is activated, the symbols are marked thickly to indicate that the symbols can be input.

Accordingly, the user can input the numerals and symbols with the same keys as those of the keyboard, and the key processing unit 200 processes and outputs the input numeral or symbol on the display.

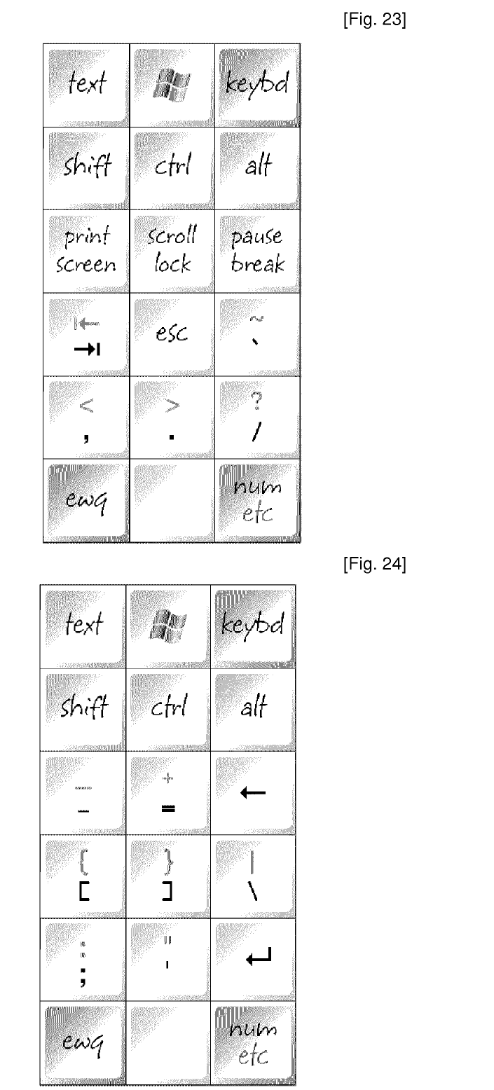

When the [num etc] key is input in FIG. 22, the key processing unit 200 assigns the symbol keys and other keys of the computer keyboard as shown in FIG. 23. The keys having two symbols are activated by toggling the [shift] key so that one of them can be input. That is, the key processing unit 200 activates lower symbols as shown in FIG. 23 when the [shift] key is not activated, while the key processing unit 200 activates upper symbols as shown in FIG. 26 when the [shift] key is activated.

Accordingly, the user can input assigned symbol keys as well as the [print screen] key, [scroll lock] key, [pause break] key, [tab] key, and [esc] key through the key array shown in FIGS. 23 and 26. In addition to the [shift] key, the other combination keys, such as [ctrl] key, [alt] key and [windows] key, can be activated to input keys.

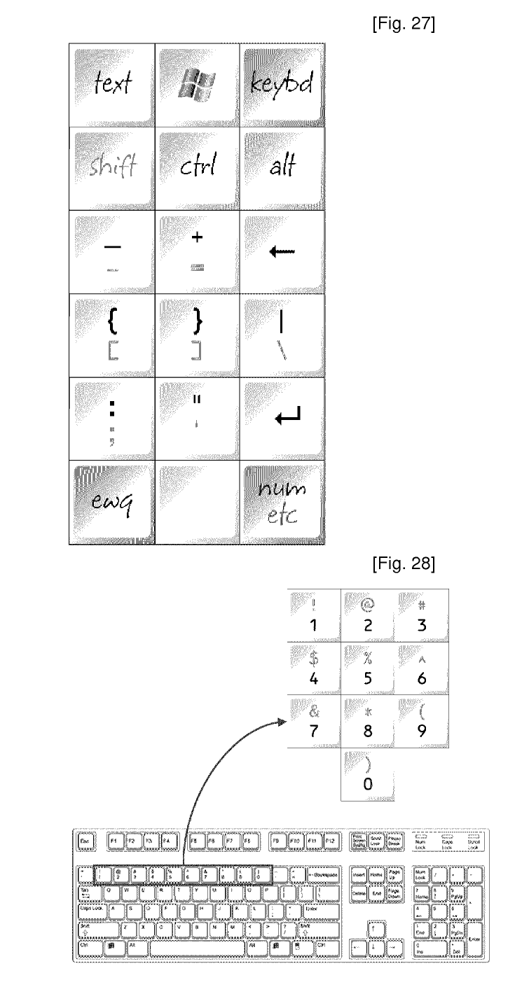

When the [num etc] key is input in FIG. 23, the key processing unit 200 assigns the symbol keys and other keys of the computer keyboard as shown in FIG. 24. As described above, the keys having two symbols are activated by toggling the [shift] key so that one of them can be input. That is, the key processing unit 200 activates lower symbols as shown in FIG. 24 when the [shift] key is not activated, while the key processing unit 200 activates upper symbols as shown in FIG. 27 when the [shift] key is activated.

Accordingly, the user can input assigned symbol keys as well as the Backspace key and Enter key through the key array shown in FIGS. 24 and 27. In addition to the [shift] key, the other combination keys, such as [ctrl] key, [alt] key and [windows] key, can be activated to input keys.

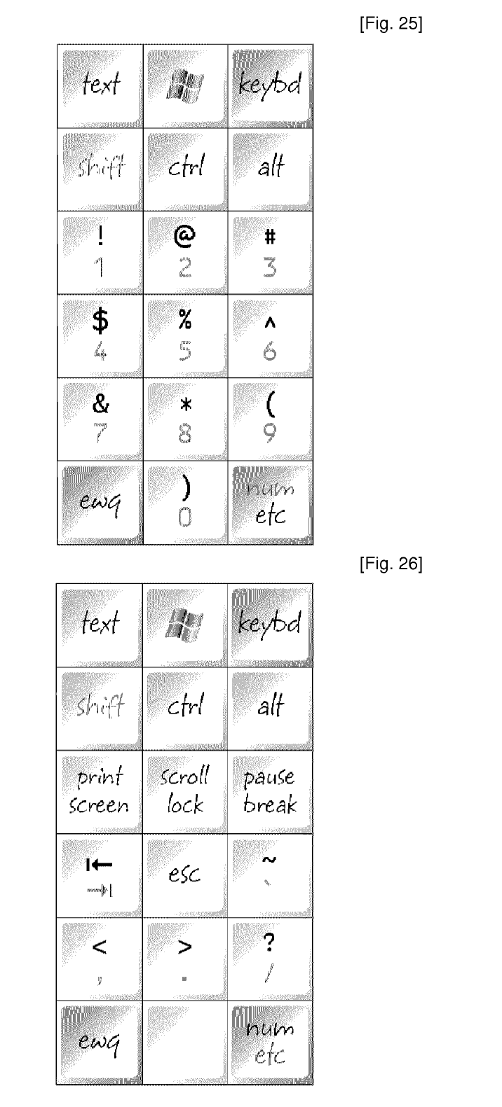

When the [num etc] key is input in FIG. 24, the key processing unit 200 assigns the keys of the key selection unit 100 as shown in FIG. 22. That is, whenever the [num etc] key is input, the key assignment is changed in the order of FIGS. 22, 23 and 24. The key assignment may be changed in the order of FIGS. 25, 26 and 27 by toggling the [shift] key.

The [num etc] key may be separated into a [num] key for numerals and an [etc] key for the others. In this case, the key processing unit 200 assigns numerals to the keys as shown in FIG. 22 when the [num] key is input, and assigns symbol keys and the other keys as shown in FIG. 23 or 24 when the [etc] key is input. The key processing unit 200 may alternately assign the keys as shown in FIGS. 23 and 24 whenever the [etc] key is input.

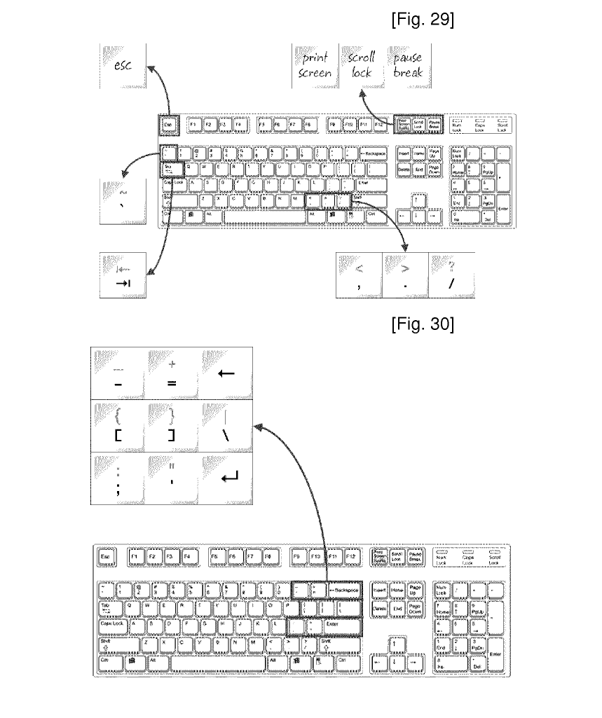

FIGS. 28 to 30 illustrate computer keyboards related to FIGS. 22 to 24, respectively.

The numeral keys, symbol keys, and the other keys of the computer keyboards assigned in FIGS. 22 to 24 are ones which are marked with thick lines in FIGS. 28 to 30.

A method for supporting supplemental functions will be described.

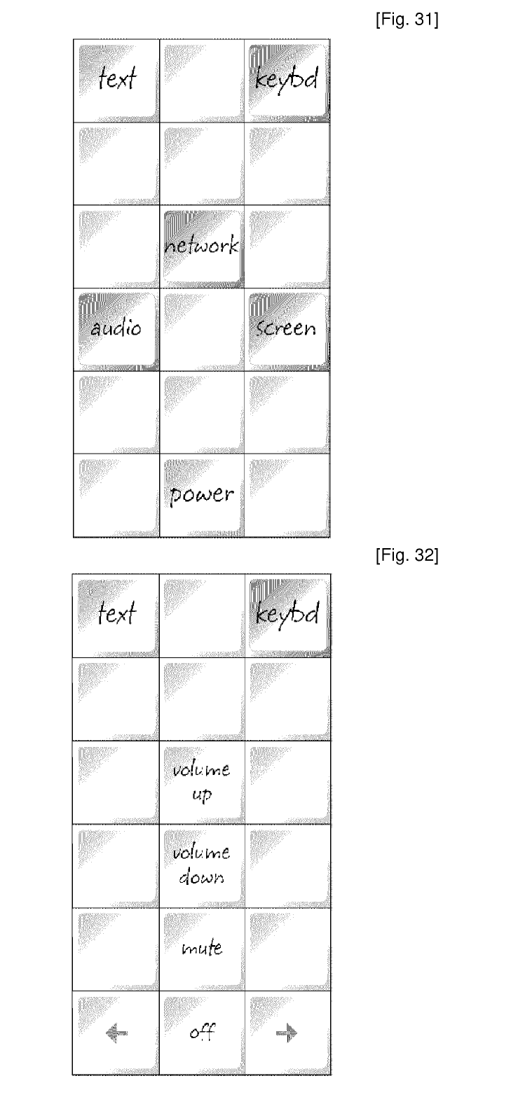

FIG. 31 illustrates assigned system keys.

When the [system] key shown in FIG. 10 is input, the key processing unit 200 assigns system-related keys, such as audio key, screen key, network key and power key, as shown in FIG. 31.

FIG. 32 illustrates assigned audio-related keys.

When the [audio] key is input in FIG. 31, the key processing unit 200 assigns audio-related keys, such as volume-control key and power key, as shown in FIG. 32.

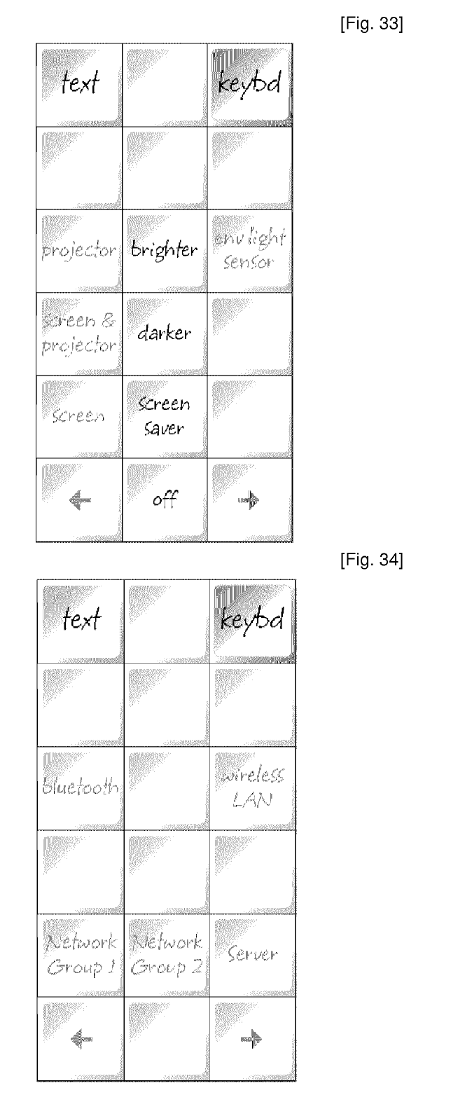

FIG. 33 illustrates assigned screen-related keys.

When the [screen] key is input in FIG. 31, the key processing unit 200 assigns screen-related keys, such as brightness-control key, projector-connection key, screensaver key, and power key, as shown in FIG. 33.

FIG. 34 illustrates assigned network-related keys.

When the [network] key is input in FIG. 31, the key processing unit 200 assigns network-related keys, such as Bluetooth, wireless LAN, and network groups, as shown in FIG. 34.

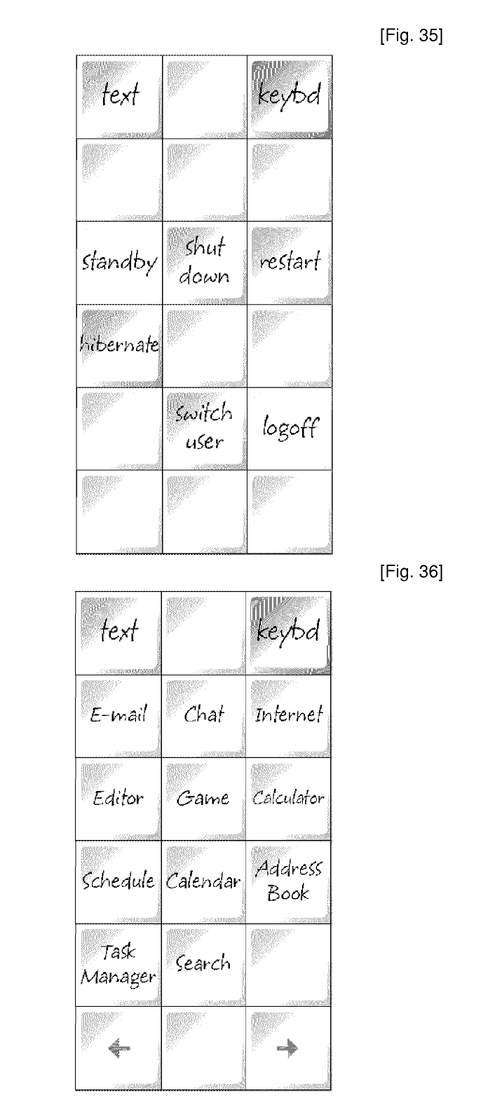

FIG. 35 illustrates assigned power-related keys.

When the [power] key is input in FIG. 31, the key processing unit 200 assigns power-related keys, such as restart, logoff, shutdown, standby etc., as shown in FIG. 35.

The above-mentioned system-related keys are preferably activated or deactivated according a given condition.

FIG. 36 illustrates assigned user-defined application keys.

When the [app] key is input in FIG. 10, the key processing unit 200 assigns user-defined application keys as shown in FIG. 36.

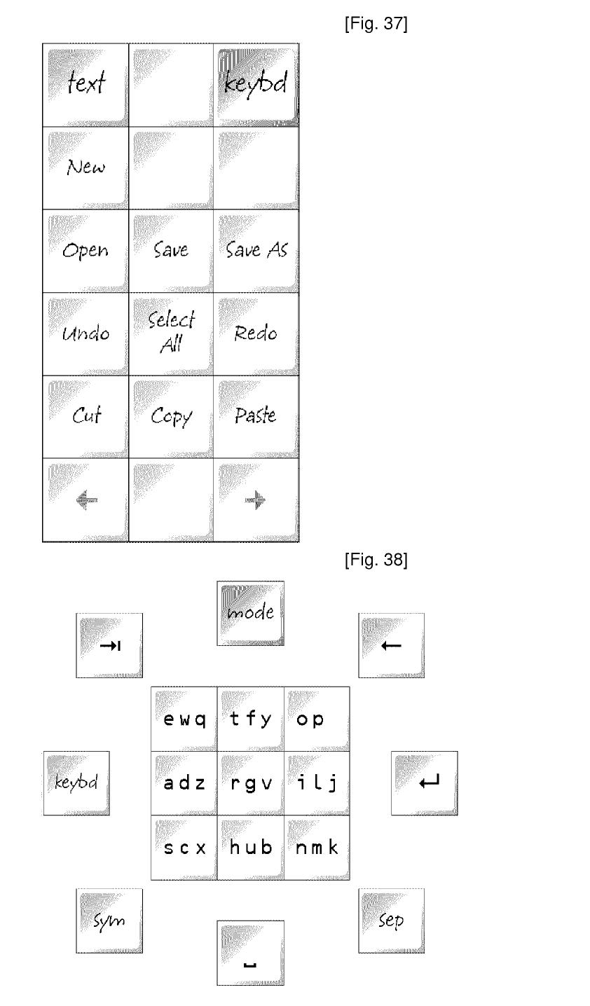

FIG. 37 illustrates assigned user-defined keys.

When the [custom] key is input in FIG. 10, the key processing unit 200 assigns user-defined keys, such as macro and batch job, as shown in FIG. 37.

When the [keybd] key is input in FIGS. 12, 14, 16 to 21, 22 to 27, and 31 to 37, the key processing unit 200 returns the key assignment of the key selection unit 100 in the keyboard mode to the default key array shown in FIG. 10.

When the [text] key is input in FIGS. 12, 14, 16 to 21, 22 to 27, and 31 to 37, the key processing unit 200 switches from the keyboard mode to the text mode. In this case, the key processing unit 200 switches to a key array of a character mode prior to switching to the keyboard mode, or to the default key array. The default key array may be one shown in FIG. 4.

The key selection unit 100 may have keys with different colors to distinguish the keys from one another. For example, blue keys indicate that some of the keys of the key selection unit 100 are reassigned to other keys, red keys indicate combination keys, and green keys indicate keys which are actually input.

FIG. 38 illustrates a key selection unit according to another exemplary embodiment of the invention.

The key selection unit has a 3-by-3 array of keys in its center, and eleven keys, which are provided around the 3-by-3 array. This reflects a joystick. That is, when a joystick is used as an external input device, a first button of the joystick is pushed to input 2-by-2 keys with the joystick centered. Although not shown, a key is mapped to the 2-by-2 keys. Furthermore, when the first button is pushed with the joystick pointing to one of eight directions, the remaining eleven keys can be input. When a second button of the joystick is pushed, keys surrounding the 3-by-3 keys to be one-to-one corresponded to the 3-by-3 keys can be input.

The above-mentioned method according to the present embodiment of the invention may be stored in any form of recording media, such as CD-ROM, RAM, ROM, floppy disk, hard disk, or magneto-optical disk, or in any computer-readable form, such as computer code organized into executable programs. A description of a method of storing an exemplary embodiment of the present invention is well known in the art and will be omitted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be efficiently applied to a method and apparatus for inputting characters as many as possible with a limited number of keys.

1. An apparatus for inputting characters provided on a computer keyboard, comprising:
a key selection unit having a limited number of keys; and
a key processing unit which assigns characters to at least some of the limited number of keys in a text mode and outputs a character of a selected key, and which assigns keys of the computer keyboard to at least some of the limited number of keys in a keyboard mode and processes a key selected by the key selection unit.

2. The apparatus of claim 1, wherein the key processing unit reassigns other keys of the computer keyboard to at least some of the limited number of keys when the key selected by the key selection unit is input in the keyboard mode.

3. The apparatus of claim 2, wherein the key processing unit assigns combination keys of the computer keyboard to at least some of the limited number of keys in the keyboard mode.

4. The apparatus of claim 3, wherein the combination keys comprise at least some of Shift key, Ctrl key, Alt key, and Windows key.

5. The apparatus of claim 4, wherein the combination keys remain assigned in the keyboard mode.

6. The apparatus of claim 3, wherein the combination keys are toggled when selected.

7. The apparatus of claim 2, wherein the key processing unit assigns function keys F1 to F12 of the computer keyboard to 15 keys of the limited number of keys when a function key selected by the key selection unit is input in the keyboard mode.

8. The apparatus of claim 2, wherein the key processing unit assigns movement keys of the computer keyboard to some of the limited number of keys when a cursor key selected by the key selection unit is input in the keyboard mode.

9. The apparatus of claim 8, wherein the movement keys comprise at least some of “←” key, “→” key, “↑” key, “↓” key, Home key, End key, Page-Up key, and Page-Down key.

10. The apparatus of claim 2, wherein the key processing unit makes a one-to-one assignment of alphabets belonging to a first character set, a second character set, or a third character set to some of the limited number of keys when a character assignment key selected by the key selection unit is input in the keyboard mode.

11. The apparatus of claim 10, wherein the key processing unit reassigns another character set when the character assignment key is input again in the keyboard mode.

12. The apparatus of claim 2, wherein the key processing unit makes a one-to-one assignment of alphabets belonging to a first character set, a second character set, and a third character set to some of the limited number of keys when a character assignment key selected by the key selection unit is input in the keyboard mode.

13. The apparatus of claim 2,
wherein the key processing unit assigns alphabets of the computer keyboard to a 3-by-3 array of nine keys among the limited number of keys when a character assignment key selected by the key selection unit is input in the keyboard mode,
wherein the alphabets are divided into a first group consisting of alphabets, which are input with a left hand, and a second group consisting of alphabets, which are input with a right hand, the alphabets belonging to the first group being arranged on the left or center columns of the 3-by-3 array, and the alphabets belonging to the second group being arranged on the right or center columns, and
wherein alphabets belonging to a first character set, a second character set, and a third character set, which are divided based on the usage frequency of the alphabets, are assigned one by one.

14. The apparatus of claim 10, wherein the key processing unit assigns lower cases or upper cases of the alphabets when the Shift key is toggled in the keyboard mode.

15. The apparatus of claim 2, wherein the key processing unit assigns keys having the numeral/symbol of the computer keyboard to some of the limited number of keys when a numeral assignment key selected by the key selection unit is input in the keyboard mode.

16. The apparatus of claim 15, wherein the key processing unit activates the keys having numeral/symbol so that the numeral/symbol can be alternately input when the Shift key is toggled.

17. The apparatus of claim 15, wherein the key processing unit assigns keys having two symbols and/or the remainder keys of the computer keyboard to some of the limited number of keys when a remainder key selected by the key selection unit is input in the keyboard mode.

18. The apparatus of claim 17, wherein the key processing unit activates the keys having two symbols so that the two symbols can be alternately input when the Shift key is toggled.

19. The apparatus of claim 17, wherein the remainder key comprises at least some of Esc key, Tab key, Enter key, Print-screen key, Scroll-lock key, and Pause-break key.

20. The apparatus of claim 17, wherein the numeral key and the remainder key are the same key, and are alternately assigned when the same key is input.

21. The apparatus of claim 2, wherein the key processing unit assigns power-related keys to some of the limited number of keys when a power key selected by the key selection unit is input in the keyboard mode.

22. The apparatus of claim 21, wherein the power-related keys comprise at least some of Reboot key, Log-off key, User-switch key, Shut-down key, Standby key, and Hibernate key.

23. The apparatus of claim 2, wherein the key processing unit assigns application keys to some of the limited number of keys when an application key selected by the key selection unit is input in the keyboard mode.

24. The apparatus of claim 2, wherein the key processing unit switches between the keyboard mode and the text mode when a mode-switch key selected by the key selection unit is input.

25. The apparatus of claim 2,
wherein the key processing unit assigns alphabets of the computer keyboard to at least some of the limited number of keys in the text mode,
wherein the alphabets of the computer keyboard are divided into a first group consisting of alphabets, which are input with a left hand, and a second group consisting of alphabets, which are input with a right hand, the alphabets belonging to the first group being arranged on the left or center columns of the 3-by-3 array, and the alphabets belonging to the second group being arranged on the right or center columns, and
wherein alphabets belonging to a first character set, a second character set, and a third character set, which are divided based on the usage frequency of the alphabets, are assigned one by one, alphabets assigned to adjacent keys of the computer keyboard being assigned to a single key or adjacent keys.

26. The apparatus of claim 2, wherein the key selection unit comprises a key which is recognized as a last input key when the key is input in the text mode.

27. The apparatus of claim 2, wherein the key processing unit sequentially assigns alphabet mode, numeral mode, and symbol mode to the key selection unit when a predetermined key is input in the text mode.

28. The apparatus of claim 2, wherein the key processing unit sequentially assigns alphabet mode, language mode, numeral mode, and symbol mode to the key selection unit when a predetermined key is input in the text mode.

29. A method for inputting characters provided on a computer keyboard, comprising: assigning characters to at least some of a limited number of keys of a key selection unit in a text mode, and outputting a character of a selected key; and assigning keys of the computer keyboard to at least some of the limited number of keys in a keyboard mode, and processing a selected key.

30. The method of claim 29, wherein assigning keys of the computer keyboard comprises reassigning other keys of the computer keyboard to at least some of the limited number of keys when a key selected by the key selection unit is input in the keyboard mode.

31. A computer readable medium having a program to execute on a computer the method of claim 29.
